(19) United States
(12) Patent Application Publication
(10) Pub. No.: US 2019/0036122 A1
(43) Pub. Date: Jan. 31, 2019

(54) ELECTROCHROMIC ELECTRODE FOR ENERGY STORAGE DEVICE

(71) Applicant: COMMISSARIAT A L'ENERGIE ATOMIQUE ET AUX ENERGIES ALTERNATIVES, Paris (FR)

(72) Inventors: Adriana Iordache, Grenoble (FR); Lionel Picard, Seyssinet-Pariset (FR); Jonathan Skrzypski, Gurgy (FR); Sébastien Solan, Seyssinet-Pariset (FR)

(21) Appl. No.: 16/077,234

(22) PCT Filed: Feb. 10, 2017
(86) PCT No.: PCT/EP2017/053055

§ 371 Date: Aug. 10, 2018

(30) Foreign Application Priority Data
Feb. 12, 2016 (FR) 16 51173

(51) Int. Cl. H01M 4/60; H01M 10/052; H01M 10/48; H01M 4/62; H01M 4/38; H01M 4/66

(52) U.S. Cl. CPC H01M 4/60; H01M 10/052; H01M 10/488; H01M 4/131; H01M 4/382; H01M 4/661; H01M 4/626

(57) ABSTRACT

The invention relates to an electrode for a lithium battery, comprising an electrochromic material as active material, and metal nanowires as electroconductive additive. Use of said electrode for making energy storage devices, the state of charge of which can be determined by calorimetric monitoring.

### TECHNICAL FIELD

The present invention is directed towards novel electrodes for an energy storage device, particularly a lithium battery, comprising as ingredients a specific active material and a specific electricity conducting material, so that it is possible in particular to view the charge status of said electrode via a simple change in colour thereof.

The invention pertains to an energy storage device comprising at least one such electrode.

The field of the invention can be defined as the field relating to energy storage devices and notably to lithium batteries.

### STATE OF THE PRIOR ART

Energy storage devices are conventionally electrochemical batteries operating along the principle of electrochemical cells capable of delivering an electrical current by means of the presence in each thereof of a pair of electrodes (respectively a positive electrode and negative electrode) separated by an electrolyte, the electrodes comprising specific materials able to react via a redox reaction after which electrons are produced resulting in the electrical current and the production of ions circulating from one electrode to the other via an electrolyte.

The most frequently employed batteries governed by this principle are lithium batteries such as lithium-ion batteries.

From an operating viewpoint, lithium-ion batteries are based on the principle of intercalation-desintercalation or complexation-decomplexation of lithium within the constituent materials of the electrodes of the electrochemical cells of the battery (these materials also possibly being called active materials).

More specifically, the reaction causing the production of current (i.e. when the battery is in discharge mode) involves the transfer, via a lithium ion conducting electrolyte, of lithium cations arriving from a negative electrode which insert themselves in the acceptor network of the positive electrode, whilst electrons derived from the reaction at the negative electrode power the external circuit with which the positive and negative electrodes are connected.

Among the active materials able to be included in the composition of at least one of the electrodes, these can be inorganic compounds able to receive lithium ions in their network that are in the process of being charged or discharged depending on the polarity of the electrodes; or organic compounds which, via a redox reaction, are able to complex said lithium ions.

These active materials are generally used in association with an electricity conducting additive such as carbon particles (carbon black in particular), and also with an additive ensuring cohesion of the electrode in which the active material and the conducting additive are included, said cohesion additive possibly being a polymeric binder, the association of these ingredients leading to a dense, opaque mixture.

With such electrodes comprising said mixture, it is therefore not possible to conduct colorimetric monitoring to determine the charge status of the electrode, when a change in status appears as a change in colour of the active material, said colour change particularly occurring with electrochromic materials, since the electricity conducting additive masks the colour change of the active material.

The need is therefore felt for a simple manner to estimate the charge status of a battery via simple colorimetric monitoring thereof, notably in the field of portable electronic equipment.

This need is henceforth met by the authors of the present invention, who have discovered that by associating a specific electricity conducting additive with a specific active material in an electrode, it has become possible to conduct estimation of charge status via mere colorimetric monitoring thereof.

### DESCRIPTION OF THE INVENTION

The invention therefore pertains to an electrode for energy storage device comprising an electrochromic material as active material and metal nanowires as electricity conducting additive.

By active material, in the foregoing and in the remainder hereof, it is meant as is conventional the material that is directly involved in the insertion-desinsertion and/or complexation-decomplexation reactions of the ions acting in the energy storage device, these ions being lithium ions when the device is a lithium battery.

By associating an active material of the electrochromic material type with metal nanowires as electricity conducting additive, it is possible to monitor the changes in colour of said electrochromic material as a function of the charge status of the electrode, without such changes being masked by the electricity conducting material as is particularly the case when it is in the form of carbon black.

For example, the electrode is deposited on a transparent substrate allowing viewing of changes in colour as a function of charge status. This substrate can ensure the function of a current collector.

The transparent substrate can be in glass or a flexible plastic material, optionally coated with an electricity conducting layer e.g. a layer in electricity conducting ceramic such as a layer of indium tin oxide.

The active material, in this invention, is an electrochromic material i.e. a material able to change colour when an electric charge is applied thereto which, in the context of the operating of the energy storage device, means when this active material is discharging.

This electrochromic material can be an inorganic material such as graphite, TiO₂ in bronze form (sometimes designated as TiO₂—B), a vanadium oxide such as V₂O₅, V₃O₇, a mixed oxide of lithium and titanium such as Li₄Ti₅O₁₂ (sometimes designated by the abbreviation LTO), lithium phosphates such LiFePO₄ (sometimes designated by the abbreviation LFP).

This material may also be an organic compound and more specifically an organic compound comprising at least one electron acceptor group such as a carbonyl group for example.

This type of compound, since it comprises an electron acceptor group and is therefore able to be reduced, can therefore be included in the composition of a positive electrode when the energy storage device in the process of discharging or in the composition of a negative electrode when the energy storage device is in the process of charging.

In particular, said compound can be an aromatic compound such as a perylene compound comprising at last one electron acceptor group such as a carbonyl group or imide group, one specific compound meeting this definition being perylene-3,4,9,10-tetracarboxylic dianhydride (symbolized by the abbreviation PTCDA) meeting following formula (I):

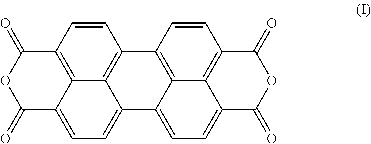 [SMILES: O=C1OC(=O)c2ccc3c4ccc5c6c(ccc(c7ccc1c2c73)c64)C(=O)OC5=O]

The active material may also be an organic compound comprising at least one electron donor group such as a carboxylate group for example.

This type of compound, since it comprises an electron donor group and is therefore able to be oxidized, can therefore be included in the composition of a negative electrode when the energy storage device is in the process of discharging, or in the composition of a positive electrode when the energy storage device is in the process of charging.

More specifically, it may be an aromatic compound such as perylene or phenylene compound, comprising at least one electron donor group such as a carboxylate group, and more particularly a lithiated carboxylate group, specific compounds which come under this definition meeting one of following formulas (II) or (III):

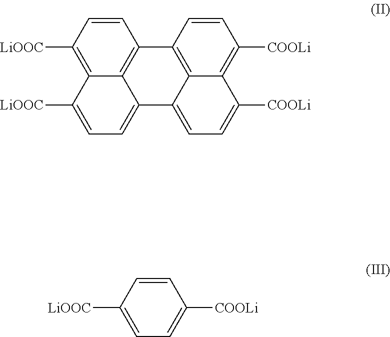

Advantageously, the electrochromic material is included in the electrode in a proportion of 45 to 99%, preferably 80% to 98% by weight relative to the total weight of the electrode.

As mentioned above, the electrodes of the invention also comprise metal nanowires as electricity conducting additive.

In the foregoing and in the remainder hereof by «nanowire» it is meant generally a wire having a thickness of between 1 and 100 nanometres but the length of which may reach up to 10 micrometres.

Aside from the fact that nanowires do not mask changes in colour of the electrochromic material, they can ensure good electronic conduction and exhibit very low percolation thresholds (approximately one percent) in the electrodes.

These metal nanowires can be nanowires in a metal selected from among copper, nickel, silver, gold, platinum, titanium, palladium, zinc, aluminium and alloys thereof, the metal advantageously being selected as a function of the range of working potentials of the active material.

For example:
copper, nickel and silver are particularly suitable for an active material having an electrochemical potential ranging from 0 to 3 V vs. Li⁰/Li⁺;
gold is particularly suitable for an active material having an electrochemical potential ranging from 1 to 4.5 V vs. Li⁰/Li⁺; and
platinum is particularly suitable for an active material having an electrochemical potential ranging from 0 to 4.5 V vs. Li⁰/Li⁺.

More specifically, the nanowires can be nanowires in copper or nanowires in gold.

From a geometric viewpoint, they may advantageously have a form factor corresponding to the ratio of nanowire length to nanowire diameter ranging from 10 to 1000000, for example higher than 30.

Advantageously, the nanowires are contained in the electrode in a proportion of 0.1 to 20%, preferably from 0.1 to 6% by weight relative to the total weight of the electrode.

In addition, the electrodes of the invention may comprise a binder, such as a polymeric binder e.g. polyvinylidene fluoride (known under the abbreviation PVDF), a mixture comprising carboxymethylcellulose (known under the abbreviation CMC) with a latex of styrene-butadiene type (known under the abbreviation SBR) or with polyacrylic acid (known under the abbreviation PAA), this binder contributing towards improving the resistance of the electrode.

Therefore, from a structural viewpoint, the electrode may be in the form of a composite material comprising a matrix of polymeric binder(s) in which fillers are dispersed composed of the active material and of the metal nanowires.

The electrodes of the invention are intended to be included in the composition of energy storage devices such as:
batteries operating with alkaline ions such as lithium batteries, sodium batteries;
batteries operating with alkaline-earth ions such as magnesium batteries;
batteries operating with organic ions.

Therefore, the invention also pertains to an energy storage device such as a lithium battery comprising at least one electrochemical cell comprising two electrodes of opposite polarity, a positive electrode and negative electrode respectively, separated by an electrolyte, at least one of the electrodes being an electrode such as defined above namely an electrode comprising an electrochromic material as active material and metal nanowires as electricity conducting additive.

The characteristics defined above for the electrodes of the invention can be applied to energy storage devices comprising said electrodes.

For example, when the electrochromic material is an organic compound comprising at least one electron attractor group, the electrode of the invention can be a positive electrode i.e. an electrode acting as cathode (therefore the site of reduction), when the generator delivers current (i.e. when it is in the process of discharging) or can be a negative electrode acting as cathode (therefore the site of reduction) when the generator is in the process of charging.

For example, when the positive electrode as electrochromic material comprises an organic compound comprising at least one electron attractor group, the negative electrode may notably be a lithium metal electrode.

Each of the electrodes is generally in contact with a current collector.

In particular, the current collector—for the electrode comprising an electrochromic material as active material and metal nanowires as electricity conducting additive—can be a transparent substrate on which the electrode can be deposited, this transparent substrate possibly being a substrate in glass for example or in a flexible plastic material optionally coated with an electricity conducting layer e.g. an electricity conducting layer in ceramic such as a layer of indium tin oxide.

The current collector may also be in the form of a metal foil or mesh e.g. in copper or aluminium.

The two electrodes of opposite polarity (namely the positive electrode and negative electrode) are separated by an electrolyte and more specifically an ion conducting electrolyte e.g. lithium ions (when the device is a lithium battery), sodium ions (wen the device is a sodium battery), magnesium ions (when the device is a magnesium battery) or organic ions (when the device is a battery operating with organic ions).

This ion conducting electrolyte can be a liquid electrolyte comprising at least one salt in one or more solvents e.g. a lithium salt (when the device is a lithium battery), a sodium salt (when the device is a sodium battery), a magnesium salt (when the device is a magnesium battery), or a salt comprising an organic ion (when the device is a battery operating with organic ions).

As examples of lithium salt, mention can be made of LiClO₄, LiAsF₆, LiPF₆, LiBF₄, LiRfSO₃, LiCH₃SO₃, LiN(RfSO₂)₂, Rf being chosen to be F or a perfluoroalkyl group having 1 to 8 carbon atoms, lithium bis(trifluoromethanesulfony)imide (known under the abbreviation LiTFSI), lithium bis(oxalato)borate (known under the abbreviation LiBOB), lithium bis(perfluorethylsulfonyl)imide (also known under the abbreviation LiBETI), lithium fluoroalkylphosphate (known under the abbreviation LiFAP), lithium 4,5-dicyano-2-(trifluoromethyl)imidazolide (known under the abbreviation LiTDI).

As examples of solvents, mention can be made of:
organic aprotic polar solvents e.g. an aprotic polar solvent selected from among carbonate solvents, ether solvents, ester solvents, sulfone solvents and nitrile solvents; or
protic solvents such as water.

In addition, the electrolyte may be caused to impregnate at least one separator element arranged between the two electrodes of the battery.

As a variant, the ion conducting electrolyte can be a polymer electrolyte or gelled electrolyte.

For example, a device conforming to the invention is a lithium battery comprising an electrochemical cell comprising:
an electrode conforming to the invention, namely more specifically a positive electrode comprising an organic compound of formula (I) such as defined above as electrochromic material, copper nanowires as electricity conducting additive and a polymeric binder e.g. polyvinylidene fluoride;
a negative electrode in lithium metal; and
an electrolyte arranged between said positive electrode and said negative electrode, said electrolyte comprising a lithium salt and at least one organic solvent from the carbonate family.

More specifically, the electrolyte may comprise a lithium salt LiPF₆ and a mixture of carbonate solvents e.g. a ternary mixture comprising ethylene carbonate, dimethyl carbonate and ethyl methyl carbonate.

Another example conforming to the invention is a lithium battery comprising an electrochemical cell, said electrochemical cell comprising:
an electrode conforming to the invention, namely more specifically a negative electrode comprising an organic compound of formula (I) such as defined above as electrochromic material, copper nanowires as electricity conducting additive and a polymeric binder e.g. polyvinylidene fluoride;
a positive electrode comprising LiFePO₄ as active material; and
an electrolyte arranged between said positive electrode and said negative electrode, said electrolyte comprising a lithium salt and at least one organic solvent from the carbonate family.

Finally, another example conforming to the invention is a lithium battery comprising an electrochemical cell comprising:
an electrode conforming to the invention, namely more specifically a positive electrode comprising Li₄Ti₅O₁₂ as electrochromic material, copper nanowires as electricity conducting additive and a polymeric binder e.g. polyvinylidene fluoride;
a negative electrode comprising lithium metal as active material; and
an electrolyte arranged between said positive electrode and said negative electrode, said electrolyte comprising a lithium salt and at least one organic solvent from the carbonate family.

Advantageously, the devices of the invention are packaged in a transparent casing to allow viewing of the electrode comprising an electrochromic material and hence the changes in the colour thereof as a function of the charge status of the electrode concerned. It is specified that the casing surrounds the constituent parts of the battery namely the electrodes and the electrolyte.

This transparent casing can be in polyethylene for example or polyethylene terephthalate or in polypropylene.

The devices of the invention are particularly suitable for the fields of application in which direct viewing of the charge status of the batteries is an advantage, such as is the case with portable electronic equipment e.g. a mobile telephone, technical textiles, timepieces.

Finally, the invention pertains to the utilisation of metal nanowires in an electrode for energy storage device such as a lithium battery comprising an electrochromic material as active material to view to the charge status of said electrode via a change in colour thereof.

The characteristics of the metal nanowires, of the electrode and of the electrochromic material defined above can be applied to this utilisation.

Other characteristics will become better apparent on reading the following additional description referring to an example of embodiment of electrodes and batteries conforming to the invention.

Evidently, the following example is merely given to illustrate the subject of the invention and is in no manner limiting thereof.

### BRIEF DESCRIPTION OF THE DRAWINGS

FIG. 1 is an exploded view illustrating a battery conforming to the invention.

FIG. 2 is a graph giving charge-discharge curves (i.e. changes in potential E (in V vs. Li⁺/Li^{o}) as a function of specific capacitance C (in mAh·g⁻¹) for two batteries conforming to the invention and one battery not conforming to the invention.

FIG. 3 is a graph giving a cycling curve (i.e. changes in intensity I (in mA) as a function of the potential E (in V vs. Li⁺/Li^{o})) obtained by cyclic voltammetry for a battery conforming to the invention.

FIG. 4 is a cycling curve (i.e. changes in intensity I (in mA) as a function of the potential E (in V vs. PTCDA)) obtained via voltammetry with the battery in Example 2.

FIG. 5 is a graph giving charge-discharge curves (i.e. changes in potential E (in V vs. Li⁺/Li^{o}) as a function of capacitance C (in mAh)) for the battery in Example 2.

FIG. 6 is a graph giving charge-discharge curves (i.e. changes in potential E (in V vs. Li⁺/Li^{o}) as a function of specific capacitance C (in mAh·g⁻¹)) for the battery in Example 3.

FIG. 7 is a curve showing changes in specific capacitance C (in mAh/g) as a function of the number of cycles N for the battery in Example 3.

### DETAILED DESCRIPTION OF PARTICULAR EMBODIMENTS

### Example 1

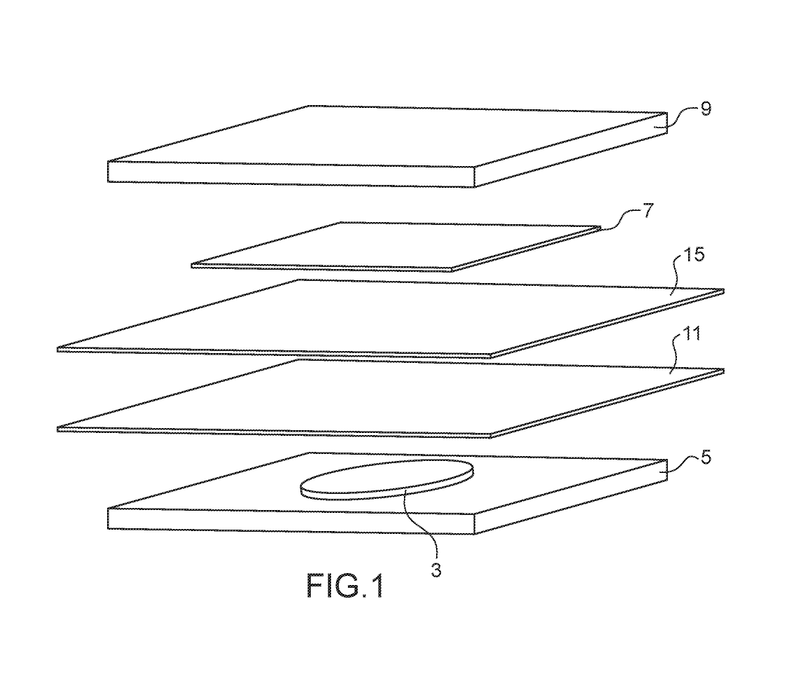

This example illustrates the preparation of two batteries conforming to the invention, each of these batteries, as illustrated in the exploded view in appended FIG. 1, comprising the following elements:
a positive electrode 3 comprising perylene-3,4,9,10-tetracarboxylic dianhydride (PTCDA) as active material, copper nanowires as electricity conducting additive and polyvinylidene fluoride as polymeric binder, said electrode being deposited on a current collector 5;
a negative electrode 7 in lithium metal deposited on a current collector 9;
an electrolyte impregnating a separator composed of two superimposed discs 11 and 15 (one disc in Celgard® and one disc in Viledon®), said electrolyte being a liquid electrolyte composed of a mixture of ethylene carbonate (⅓ by volume), ethyl methyl carbonate (⅓ by volume) and dimethyl carbonate (⅓ by volume) and 1 mol/L of LiPF₆.

a) Preparation of Copper Nanowires

First, a solution of 2000 mL of NaOH at 15 mol·L⁻¹ is prepared in a 3-litre round bottom flask by dissolving 1200 g of NaOH in 2000 mL of deionized water (hereafter called first solution).

In parallel, a solution of copper nitrate at 0.2 mol·L⁻¹ is prepared by adding 4.65 g of Cu(NO₃)₂ to 100 mL of deionized water.

This solution is added to the first solution, after which the addition is made of 30 mL ethylenediamine (EDA) and 2.5 mL hydrated hydrazine (35 weight %).

The reaction medium is heated to 80° C. for one hour under vigorous agitation.

The solution changes from a royal blue colour to a reddish-brown colour indicating the formation of copper metal nanowires.

The nanowires are collected by centrifugation and washed in an aqueous solution with 3 weight % hydrazine and finally stored in a bottle containing a solution of same type (3 weight % hydrazine) under an argon atmosphere to prevent oxidation thereof.

The copper nanowires obtained have a form factor (corresponding to the ratio between the length and diameter of the nanowires) higher than 30, with a length estimated by scanning electron microscopy of about 5 μm and diameter estimated by scanning electron microscopy of about 150 nm.

b) Preparation of Electrodes Conforming to the Invention

Initially, a suspension is prepared comprising copper nanowires prepared at above-mentioned step a), polyvinylidene fluoride (PVDF) and N-methyl pyrrolidone (NMP) at respective weight contents of 1%, 0.5% and 98.5%, the whole being dispersed for 1 hour in a sonotrode. Next, perylene-3,4,9,10-tetracarboxylic dianhydride (PTCDA) and PVDF/NMP are added to the suspension, the mixture being dispersed using a Dispermat mixer. The resulting ink comprises 86 weight % PTCDA, 4 weight % copper nanowires and 10 weight % polyvinylidene fluoride (weight percentages being expressed relative to the total weight of these three ingredients).

In a first variant, the above-mentioned ink is deposited on copper foil then dried in an oven at 55° C. for 24 hours. A circular piece 14 mm in diameter is cut out using a punch, said piece then being dried in a Buchi at 80° C. for 48 hours, the resulting piece forming a positive electrode (called first electrode) deposited on a copper collector.

In a second variant, the above-mentioned ink is deposited by spraying, using an airbrush gun, onto a transparent wafer coated with a template formed of a glass substrate coated with an indium tin oxide layer. The resulting piece is then dried in an oven at 55° C. for 24 hours, after which a second positive electrode is obtained.

c) Preparation of the Batteries Conforming to the Invention

A first battery conforming to the invention is prepared from the first electrode defined under paragraph b) above.

More specifically, this first battery is a battery of button cell type respectively comprising:
a negative electrode disc in lithium metal;
the first positive electrode defined under paragraph b); and
a separator composed of the superimposition of a disc in Viledon® (reference FS2207-25-DA WA) (this being a membrane in nonwoven fibres of polyolefins—polypropylene/polyethylene) and a disc in Celgard® (reference C2400) (a polypropylene membrane), said separator being impregnated with an electrolyte composed of a mixture of ethylene carbonate (⅓ by volume), ethyl methyl carbonate (⅓ by volume) and dimethyl carbonate (⅓ by volume) and 1 mol/L of LiPF₆.

A second battery conforming to the invention is prepared from the second electrode defined under paragraph b) above.

More specifically, this second battery is a battery of PouchCell type respectively comprising:
a negative electrode disc in lithium metal;
the second positive electrode defined under paragraph b); and
a separator composed of the superimposition of a disc in Viledon® (reference FS2207-25-DA WA) (this being a membrane in nonwoven fibres of polyolefins—polypropylene/polyethylene) and a disc in Celgard® (reference C2400) (a membrane in polypropylene), said separator being impregnated with an electrolyte composed of a mixture of ethylene carbonate (⅓ by volume), ethyl methyl carbonate (⅓ by volume) and dimethyl carbonate (⅓ by volume) and 1 mol/L of LiPF₆.

This second battery is placed in a flexible transparent casing in polyethylene so that it is possible to view changes in colour of the positive electrode as a function of the charge status thereof.

This second battery is subjected to a discharging process which, from a chemical viewpoint, corresponds to reducing the PTCDA, and the change in colour of the positive electrode is examined through the transparent flexible casing.

As and when it discharges, a red colour is seen to change to a much darker colour tending towards purple.

With the electrode and batteries of the invention, it is thus possible to view the change in charge status of the battery simply via a mere change in colour of the positive electrode.

In parallel, the electrochemical performances of the batteries conforming to the invention were also tested.

A charge/discharge profile was therefore determined for the first battery as compared with a battery not conforming to the invention in which the copper nanowires were replaced by carbon black of Super P type, the proportions of the ingredients of the positive electrode respectively being 75 weight % for PTCDA, 20 weight % for carbon black and 5 weight % for PVDF.

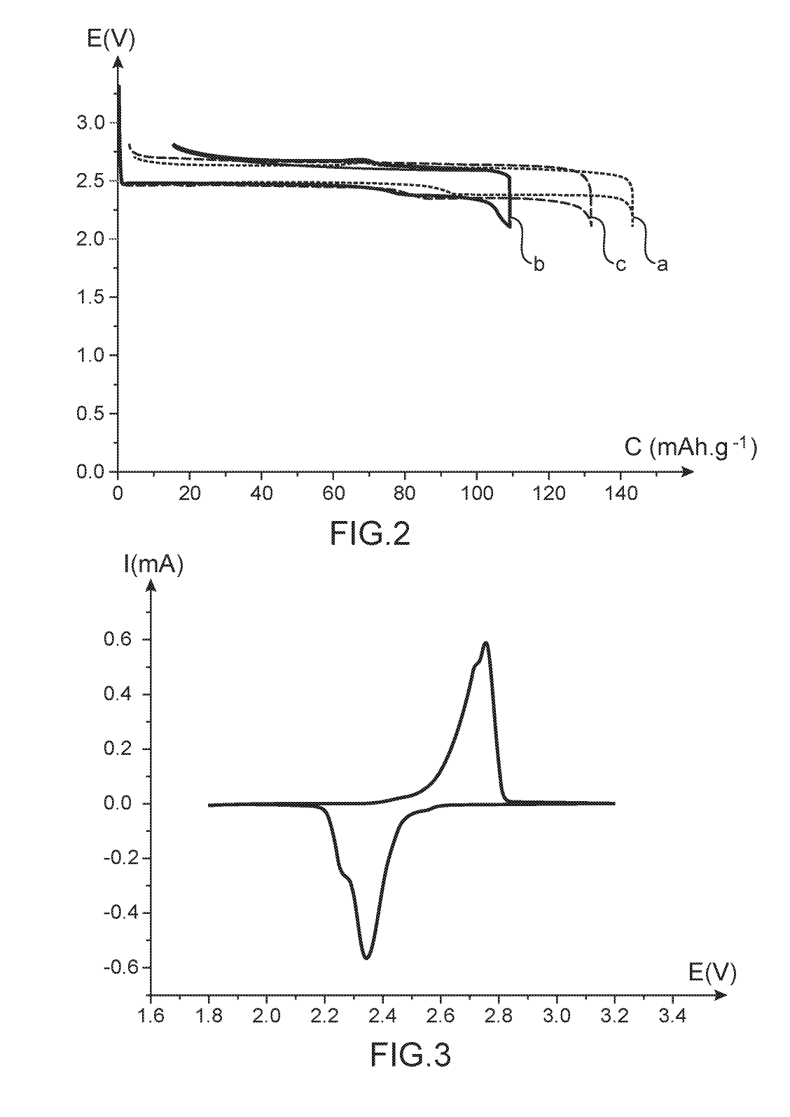

The curves are given in FIG. 2, with curve a) for the first battery, curve b) for the second battery and curve c) for the battery not conforming to the invention.

They exhibit a relatively similar profile evidencing the fact that the copper nanowires do not perturb the electrochemical performance of the batteries.

A cyclic voltammetry test was also conducted with the first battery, whereby cycling was performed at between 1.8 V and 3.2 V vs. Li⁺/Li⁰ at a scanning rate of 0.1 mV·s⁻¹, the cycling curve being illustrated in FIG. 3. This Figure shows a reduction peak at 2.8 V corresponding to the reduction peak of the carbonyl function and an oxidation peak at 2.3V corresponding to the oxidation peak of the enolate functions thus created, these two peaks evidencing the reversibility of PTDCA.

### Example 2

This example illustrates the preparation of a battery of button cell type conforming to the invention, said battery comprising:
a negative electrode comprising perylene-3,4,9,10-tetracarboxylic dianhydride (PTCDA) as active material, copper nanowires as electricity conducting additive and polyvinylidene fluoride as polymeric binder, said electrode being deposited on a current collector;
an electrode comprising LiFePO₄ as active material deposited on a current collector;
an electrolyte impregnating a separator composed of two superimposed discs (one disc in Celgard® and one disc in Viledon®), said electrolyte being a liquid electrolyte composed of a mixture of ethylene carbonate (⅓ by volume), ethyl methyl carbonate (⅓ by volume) and dimethyl carbonate (⅓ by volume) and 1 mol/L of LiPF₆.

This battery was prepared along the same modalities as those set forth in Example 1, with the exception that the positive electrode in Example 1 becomes the negative electrode in this Example 2, and the positive electrode of this Example comprises LiFePO₄.

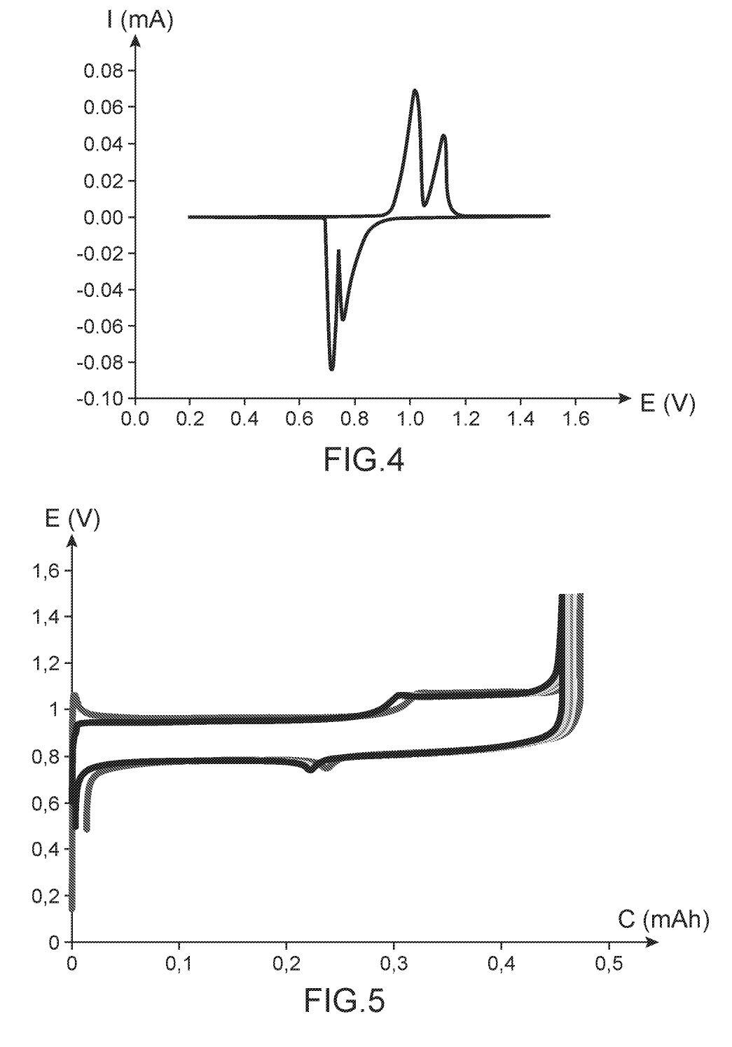

A cyclic voltammetry test was carried out with this battery, whereby cycling was performed at between 0.2 V and 1.5 V vs. Li⁺/Li⁰ at a scanning rate of 0.01 mV·s⁻¹, the cycling curve being illustrated in FIG. 4. In this Figure a reduction peak at 1.8 V can be seen corresponding to the reduction peak of the anhydride function and an oxidation peak at 0.7 V corresponding to the oxidation peak of the carboxylate functions thus created, these two peaks evidencing the reversibility of PTDCA.

A charge/discharge profile was also determined at C10 rate with this battery, 5 charge/discharge cycles being carried out, the curves of 5 cycles being given in FIG. 5. These curves overlay each other, evidencing the stability of the battery.

### Example 3

This example illustrates the preparation of a battery of button cell type conforming to the invention, said battery comprising:
a positive electrode comprising Li₄Ti₅O₁₂ as active material, copper nanowires as electricity conducing additive, and polyvinylidene fluoride as polymeric binder, said electrode being deposited on a current collector;
a negative electrode in lithium metal deposited on a current collector;
an electrolyte impregnating a separator composed of two superimposed discs (a disc in Celgard® and a disc in Viledon®), said electrolyte being a liquid electrolyte composed of a mixture of ethylene carbonate (⅓ by volume), ethyl methyl carbonate (⅓ by volume) and dimethyl carbonate (⅓ by volume) and 1 mol/L of LiPF₆.

The active material Li₄Ti₅O₁₂ is an electrochromic material able to change from a white colour to a dark blue colour as a function of the charge status thereof.

This battery was prepared along the same modalities as those set forth in Example 1 with the exception that the positive electrode was prepared in accordance with the following protocol.

A solution containing copper nanowires, polyvinylidene fluoride (PVdF) and N-methylpyrrolidone (NMP) was prepared by dispersion using a sonotrode for 1 hour, this solution comprising 1 weight % copper nanowires, 0.5 weight % PVDF and 98.5 weight % NMP. Li₄Ti₅O₁₂ was added thereto and the mixture dispersed in a Dispermat. The composition of the coloured ink obtained was approximately 90% Li₄Ti₅O₁₂, 4% copper nanowires and et 6% PVdF. This ink was coated onto copper collectors then dried in an oven at 55° C. for 24 hours. An electrode 14 mm in diameter was cut out with a punch and dried in a Buchi at 80° C. for 48 hours.

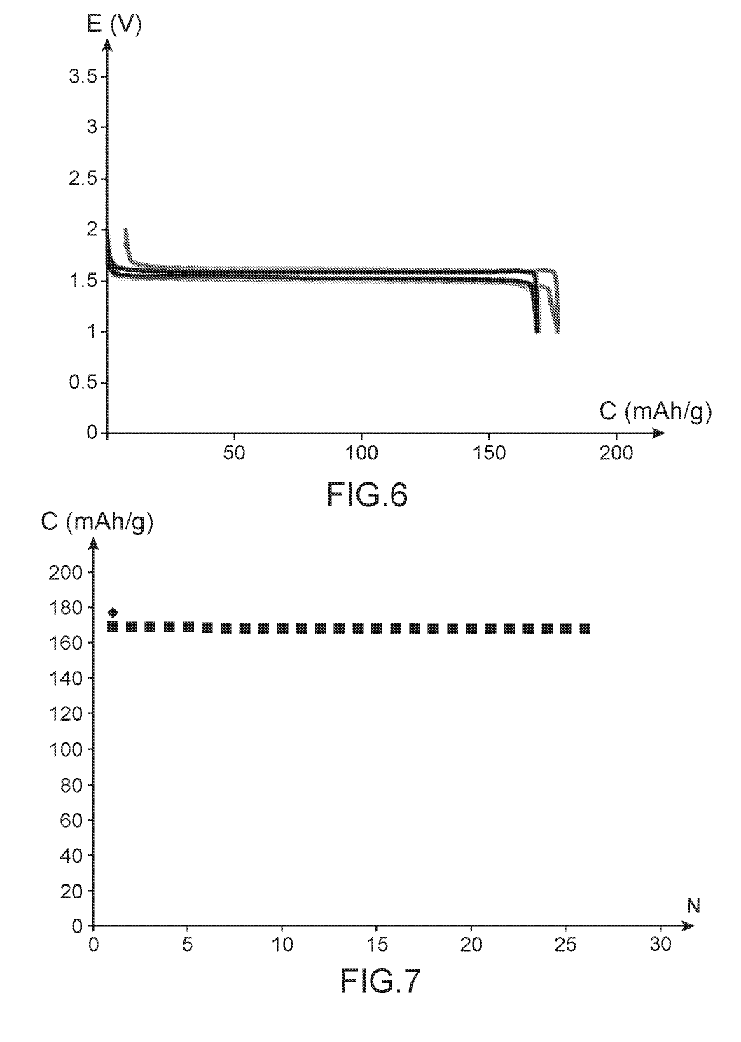

A charge/discharge profile at C10 rate was also determined for this battery, 5 charge/discharge cycles being performed; the curves of 5 cycles are given in FIG. 6. These curves overlay each other, evidencing the stability of the battery.

The trend in specific capacitance C (in mAh/g) was also determined as a function of the number of cycles N, the results being given in FIG. 7. It was shown that specific capacitance remained substantially constant over the 25 cycles performed.

1. An electrode for an energy storage device, said electrode comprising an electrochromic material as an active material and metal nanowires as an electricity conducting additive.

2. The electrode according to claim 1, that is deposited on a transparent substrate.

3. The electrode according to claim 1, wherein the electrochromic material is an organic compound.

4. The electrode according to claim 1, wherein the electrochromic material is an organic compound comprising at least one electron acceptor group.

5. The electrode according to claim 1, wherein the electrochromic material is an aromatic compound comprising at least one electron acceptor group.

6. The electrode according to claim 1, wherein the electrochromic material is a perylene compound comprising at least one electron acceptor group.

7. The electrode according to claim 4, wherein the electron acceptor group is a carbonyl group.

8. The electrode according to claim 1, wherein the electrochromic material is a compound of formula (I):

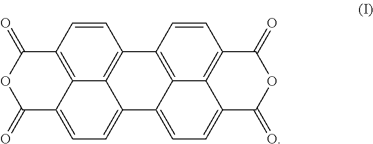 [SMILES: O=C1OC(=O)c2ccc3c4ccc5c6c(ccc(c7ccc1c2c73)c64)C(=O)OC5=O]

9. The electrode according to claim 1, wherein the electrochromic material is an organic compound comprising at least one electron donor group.

10. The electrode according to claim 1, wherein the electrochromic material is an organic compound comprising an electron donor group which is a carboxylate group.

11. The electrode according to claim 1, wherein the electrochromic material is a perylene or phenylene compound comprising at least one electron donor group such as a carboxylate group.

12. The electrode according to claim 1, wherein the electrochromic material is a compound of formula (II) or (III):

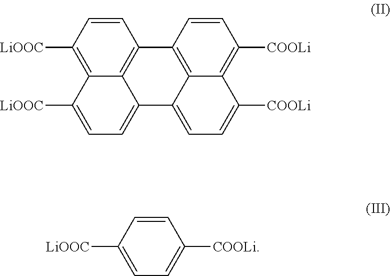

13. The electrode according to claim 1, wherein the metal nanowires are nanowires of a metal selected from among copper, nickel, silver, gold, platinum, titanium, palladium, zinc, aluminium, and alloys thereof.

14. The electrode according to claim 1, wherein the metal nanowires are nanowires of copper or of gold.

15. The electrode according to claim 1, wherein the metal nanowires have a form factor corresponding to the ratio between the length and diameter of the nanowire ranging from 10 to 1,000,000.

16. The electrode according to claim 1, that comprises a polymeric binder.

17. The electrode according to claim 1, wherein the electrochromic material is an inorganic material.

18. The electrode according to claim 1, wherein the electrochromic material is an inorganic material selected from among graphite, TiO₂ in bronze form, a vanadium oxide, a mixed lithium and titanium oxide and a lithium phosphate.

19. An energy storage device comprising at least one electrochemical cell comprising two electrodes of opposite polarity, respectively a positive electrode and negative electrode separated by an electrolyte, at least one of the electrodes being an electrode of claim 1.

20. The device according to claim 19, that is a lithium battery.

21. The device according to claim 19, that is a lithium battery comprising an electrochemical cell comprising:
a positive electrode comprising an organic compound of formula (I) 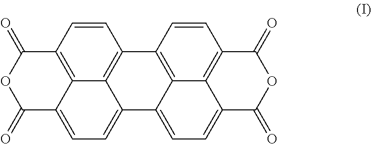 [SMILES: O=C1OC(=O)c2ccc3c4ccc5c6c(ccc(c7ccc1c2c73)c64)C(=O)OC5=O]
as an electrochromic material, copper nanowires as an electricity conducting additive, and a polymeric binder;
a negative electrode of lithium metal; and
an electrolyte arranged between said positive electrode and said negative electrode, said electrolyte comprising a lithium salt and at least one organic solvent from the carbonate family.

22. The device according to claim 19, that is a lithium battery comprising an electrochemical cell comprising:
a negative electrode comprising an organic compound of formula (I) 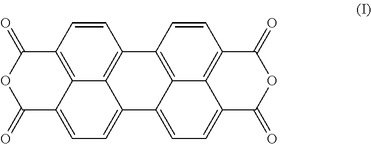 [SMILES: O=C1OC(=O)c2ccc3c4ccc5c6c(ccc(c7ccc1c2c73)c64)C(=O)OC5=O]
as an electrochromic material, copper nanowires as an electricity conducting additive, and a polymeric binder;
a positive electrode comprising LiFePO₄ as an active material; and
an electrolyte arranged between said positive electrode and said negative electrode, said electrolyte comprising a lithium salt and at least one organic solvent from the carbonate family.

23. The device according to claim 19, that is a lithium battery comprising an electrochemical cell comprising:
a positive electrode comprising Li₄Ti₅O₁₂ as an electrochromic material, copper nanowires as an electricity conducting additive, and a polymeric binder;
a negative electrode comprising lithium metal as an active material; and
an electrolyte arranged between said positive electrode and said negative electrode, said electrolyte comprising a lithium salt and at least one organic solvent from the carbonate family.

24. The device according to claim 19 packaged in a transparent casing.

25. Use of metal nanowires in an electrode for energy storage device comprising an electrochromic material as active material to view the charge status of said electrode via a change in colour thereof.
